(19) United States
(12) Patent Application Publication
(10) Pub. No.: US 2023/0105422 A1
(43) Pub. Date: Apr. 6, 2023

(54) ANALOGUE IDENTIFICATION AND EVALUATION FOR FIELD DEVELOPMENT AND PLANNING

(71) Applicant: SCHLUMBERGER TECHNOLOGY CORPORATION, Sugar Land, TX (US)

(72) Inventors: Robin PICKLES, Prestwood (GB); Richard TORRENS, Barton Stacey (GB); Stephen FREEMAN, Notts (GB); Ranjit Ramchandra VHANAMANE, Pimpri Chinchwad (IN); Gelmis RADECKIS, Leeds (GB); Kwangwon PARK, Houston, TX (US)

(21) Appl. No.: 18/063,778

(22) Filed: Dec. 9, 2022

Related U.S. Application Data
(63) Continuation of application No. PCT/US2021/036352, filed on Jun. 8, 2021.
(60) Provisional application No. 63/036,925, filed on Jun. 9, 2020.

(51) Int. Cl. G06Q 30/0202; G06Q 50/02

(52) U.S. Cl. CPC G06Q 30/0202; G06Q 50/02

(57) ABSTRACT

A method includes receiving one or more parameters of a plurality of oilfield projects and one or more economic indicators of the plurality of oilfield projects, receiving one or more parameters of a prospective oilfield project, comparing the prospective oilfield project with the plurality of oilfield projects based on the one or more parameters of the prospective oilfield project and the one or more parameters of the plurality of oilfield projects, using a machine learning model, and predicting one or more economic indicators for the prospective oilfield project based at least in part on the comparing.

### CROSS-REFERENCE TO RELATED APPLICATIONS

This application is a continuation of PCT Application No. PCT/US2021/036352, which was filed on Jun. 8, 2021, which in turn claims priority to U.S. Provisional Patent App. Ser. No. 63/036,925, which was filed on Jun. 9, 2020. The contents of the foregoing applications are incorporated herein by reference in its entirety.

### BACKGROUND

Field development planning is a process used in various industries as a guide for development and utilization of a field, e.g., an energy field, such as an oilfield, wind field, solar array, geothermal, hydrothermal, or hydrogen gas installation, etc. Development managers create the plan based on knowledge and experience, e.g., based on historical field development information from similar fields. For example, managers may access databases of historical fields along with the fields under production. This information may be used to identify similar field developments, which are known as “analogues”, from which insights into a prospective field developments may be gleaned. Thus, analogues assist in understanding risks and economic constraints for a field development project.

Statistical properties of the set of analogue fields may provide references or benchmarks for new field developments. For example, a capital expenditures (CAPEX) estimation of the current development plan may be considered more likely in view of similar average CAPEXs from analogue fields.

Accurate identification of similar oilfields, and selection of appropriate parameters to define “similar”, may present difficulties. For example, it may be difficult to identify similar fields when considering multiple properties at the same time; however, such a holistic identification process may identify analogues more accurately. Thus, searching for similar fields can be time consuming of comparing multiple different factors individually. Further, such human-led processes may be subjective and imprecise, e.g., especially when selecting among fields that are similar to one another.

### SUMMARY

Embodiments of the disclosure include a method that includes receiving one or more parameters of a plurality of oilfield projects and one or more economic indicators of the plurality of oilfield projects, receiving one or more parameters of a prospective oilfield project, comparing the prospective oilfield project with the plurality of oilfield projects based on the one or more parameters of the prospective oilfield project and the one or more parameters of the plurality of oilfield projects, using a machine learning model, and predicting one or more economic indicators for the prospective oilfield project based at least in part on the comparing.

In an embodiment, the method further includes generating first vectors that represent the one or more parameters of the plurality of oilfield projects, and generating a second vector that represents at least the one or more parameters of the prospective oilfield project. In such an embodiment, comparing includes generating similarity scores by comparing the second vector with the individual first vectors, selecting, as one or more analogues, one or more of the plurality of oilfield projects based on the similarity scores.

In an embodiment, predicting the one or more economic indicators is based at least in part on the one or more economic indicators of the one or more analogues, and not on the one or more economic indicators of the plurality of oilfield projects that are not selected as analogues.

In an embodiment, the method also includes training a second machine learning model to predict the one or more economic indicators of the prospective oilfield project by inputting training data representing the one or more parameters of the oilfield projects that were selected as analogues and the one or more economic indicators of the oilfield projects that were selected as analogues. In such an embodiment, predicting includes using the trained second machine learning model to predict the one or more economic indicators of the prospective oilfield project.

In an embodiment, generating individual first vectors of the plurality of first vectors includes generating a vectorized representation of the one or more parameters, and generating an embedding from the vectorized representation using an autoencoder neural network such that a dimensionality of the vectorized representation is reduced.

In an embodiment, the one or more parameters of the plurality of oilfield projects are different between different oilfield projects of the plurality of oilfield projects, and are selected from: location, area, basin, gas in place, oil in place, field terrain, maximum water depth, oil and gas reserves, resource type, trap type, formation rock type, gas oil ratio, gravity, carbon dioxide content, sulphur content, economic indicators, decisions related to the field development, wells, operators, contractor identities, and infrastructure. Further, the one or more economic indicators are selected from: capital expenditures, operating expenditures, total production, cost per unit of hydrocarbon, internal rate of return, and recovery factor.

In an embodiment, the method also includes ranking the prospective oilfield project against one or more other prospective oilfield projects based at least in part on the predicted one or more economic indicators of the prospective oilfield project, and selecting the prospective oilfield project for implementation based at least in part on the ranking.

In an embodiment, the method also includes visualizing the predicted one or more economic indicators of the prospective oilfield project and the one or more oilfield projects that were selected as analogues.

Embodiments of the disclosure also include a computing system including one or more processors, and a memory system including one or more non-transitory computer-readable media storing instructions that, when executed by at least one of the one or more processors, cause the computing system to perform operations. The operations include receiving one or more parameters of a plurality of oilfield projects and one or more economic indicators of the plurality of oilfield projects, receiving one or more parameters of a prospective oilfield project, comparing the prospective oilfield project with the plurality of oilfield projects based on the one or more parameters of the prospective oilfield project and the one or more parameters of the plurality of oilfield projects, using a machine learning model, and predicting one or more economic indicators for the prospective oilfield project based at least in part on the comparing.

Embodiments of the disclosure include a computing system configured to receive one or more parameters of a plurality of oilfield projects and one or more economic indicators of the plurality of oilfield projects, receive one or more parameters of a prospective oilfield project, compare the prospective oilfield project with the plurality of oilfield projects based on the one or more parameters of the prospective oilfield project and the one or more parameters of the plurality of oilfield projects, using a machine learning model, and predict one or more economic indicators for the prospective oilfield project based at least in part on the comparing.

Embodiments of the disclosure also include a computing system including means for receiving one or more parameters of a plurality of oilfield projects and one or more economic indicators of the plurality of oilfield projects, means for receiving one or more parameters of a prospective oilfield project, means for comparing the prospective oilfield project with the plurality of oilfield projects based on the one or more parameters of the prospective oilfield project and the one or more parameters of the plurality of oilfield projects, using a machine learning model, and means for predicting one or more economic indicators for the prospective oilfield project based at least in part on the comparing.

Embodiments of the disclosure include a method that includes receiving one or more parameters of a plurality of projects and one or more economic indicators of the plurality of projects, receiving one or more parameters of a prospective project, comparing the prospective project with the plurality of projects based on the one or more parameters of the prospective project and the one or more parameters of the plurality of projects, using a machine learning model, and predicting one or more economic indicators for the prospective project based at least in part on the comparing.

In an embodiment, the method may include generating first vectors that represent the one or more parameters of the plurality of projects, and generating a second vector that represents at least the one or more parameters of the prospective project. In this embodiment, comparing may include generating similarity scores by comparing the second vector with the individual first vectors, and selecting, as one or more analogues, one or more of the plurality of projects based on the similarity scores.

In an embodiment, predicting the one or more economic indicators is based at least in part on the one or more economic indicators of the one or more analogues, and not on the one or more economic indicators of the plurality of projects that are not selected as analogues.

In an embodiment, the method also includes training a second machine learning model to predict the one or more economic indicators of the prospective project by inputting training data representing the one or more parameters of the projects that were selected as analogues and the one or more economic indicators of the projects that were selected as analogues. In an embodiment, predicting includes using the trained second machine learning model to predict the one or more economic indicators of the prospective project.

In an embodiment, generating individual first vectors of the plurality of first vectors includes generating a vectorized representation of the one or more parameters, and generating an embedding from the vectorized representation using an autoencoder neural network such that a dimensionality of the vectorized representation is reduced.

In an embodiment, the plurality of projects are oilfield projects, and the prospective project is a prospective oilfield project. In an embodiment, the one or more parameters of the plurality of projects are different between different projects of the plurality of projects, and are selected from the group consisting of: location, area, basin, gas in place, oil in place, field terrain, maximum water depth, oil and gas reserves, resource type, trap type, formation rock type, gas oil ratio, gravity, carbon dioxide content, sulphur content, economic indicators, decisions related to the field development, wells, operators, contractor identities, and infrastructure. In an embodiment, the one or more economic indicators are selected from the group consisting of: capital expenditures, operating expenditures, total production, cost per unit of hydrocarbon, net present value, internal rate of return, and recovery factor.

In an embodiment, the method also includes ranking the prospective project against one or more other prospective projects based at least in part on the predicted one or more economic indicators of the prospective project, and selecting the prospective project for implementation based at least in part on the ranking.

In an embodiment, the method includes visualizing the predicted one or more economic indicators of the prospective project and the one or more projects that were selected as analogues.

Embodiments of the disclosure also include a computing system including one or more processors, and a memory system including one or more non-transitory, computer-readable media storing instructions that, when executed by at least one of the one or more processors, cause the computing system to perform operations. The operations include receiving one or more parameters of a plurality of projects and one or more economic indicators of the plurality of projects, receiving one or more parameters of a prospective project, comparing the prospective project with the plurality of projects based on the one or more parameters of the prospective project and the one or more parameters of the plurality of projects, using a machine learning model, and predicting one or more economic indicators for the prospective project based at least in part on the comparing.

Embodiments of the disclosure include a non-transitory computer-readable medium storing instructions that, when executed by at least one processor of a computing system, cause the computing system to perform operations. The operations include receiving one or more parameters of a plurality of oilfield projects and one or more economic indicators of the plurality of oilfield projects, receiving one or more parameters of a prospective oilfield project, comparing the prospective oilfield project with the plurality of oilfield projects based on the one or more parameters of the prospective oilfield project and the one or more parameters of the plurality of oilfield projects, using a machine learning model, and predicting one or more economic indicators for the prospective oilfield project based at least in part on the comparing.

Embodiments of the disclosure also include a computing system configured to receive one or more parameters of a plurality of projects and one or more economic indicators of the plurality of projects, to receive one or more parameters of a prospective project, to compare the prospective project with the plurality of projects based on the one or more parameters of the prospective project and the one or more parameters of the plurality of projects, using a machine learning model, and to predict one or more economic indicators for the prospective project based at least in part on the comparing.

Embodiments of the disclosure also include a computing system means for receiving one or more parameters of a plurality of projects and one or more economic indicators of the plurality of projects, means for receiving one or more parameters of a prospective project, means for comparing the prospective project with the plurality of projects based on the one or more parameters of the prospective project and the one or more parameters of the plurality of projects, using a machine learning model, and means for predicting one or more economic indicators for the prospective project based at least in part on the comparing.

Thus, the computing systems and methods disclosed herein are more effective methods for processing collected data that may, for example, correspond to a surface and a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a flowchart of a method for field development planning, including using artificial intelligence, according to an embodiment.

FIG. 5 illustrates a diagram of a system for field planning and development, according to an embodiment.

FIG. 6 illustrates another flowchart of a method for field development and planning, according to an embodiment.

FIG. 7 illustrates a flowchart of a method for training a machine learning model to construct embeddings, according to an embodiment.

FIGS. 8A and 8B conceptually illustrate operation of the machine learning model to generate the embeddings, and then a comparison made therefrom, according to an embodiment.

FIGS. 9A, 9B, and 9C illustrate a flowchart of a method, according to an embodiment.

FIG. 10 illustrates a side elevational view of a wind turbine, according to an embodiment.

FIG. 11 illustrates a wind turbine farm, according to an embodiment.

FIG. 12 illustrates a solar panel, according to an embodiment.

FIG. 13 illustrates a solar panel farm, according to an embodiment.

FIG. 14 illustrates an ocean power generation farm, according to an embodiment.

FIG. 15 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed. Various embodiments of the disclosure may apply to different types of projects, e.g., energy projects, such as oilfield projects or alternative/renewable energy projects.

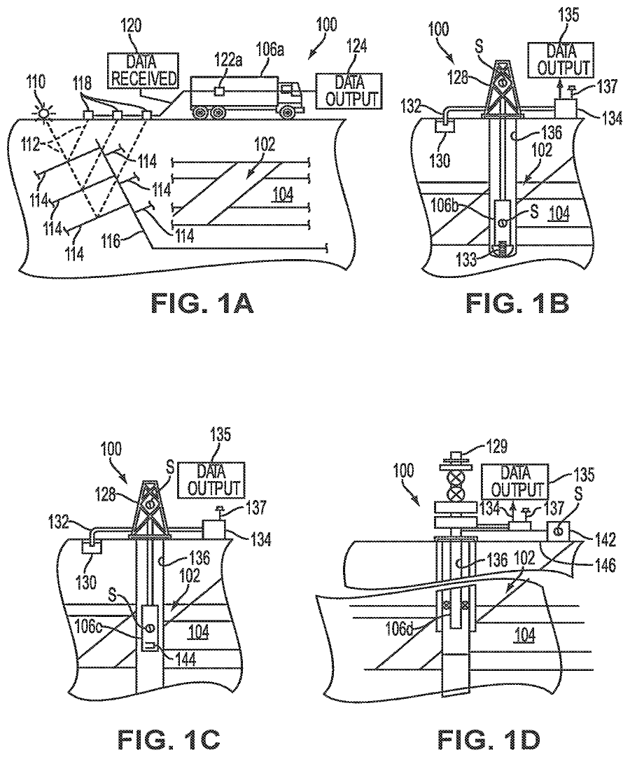

Considering the oilfield projects as one illustrative example, FIGS. 1A-1D depict simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more well sites.

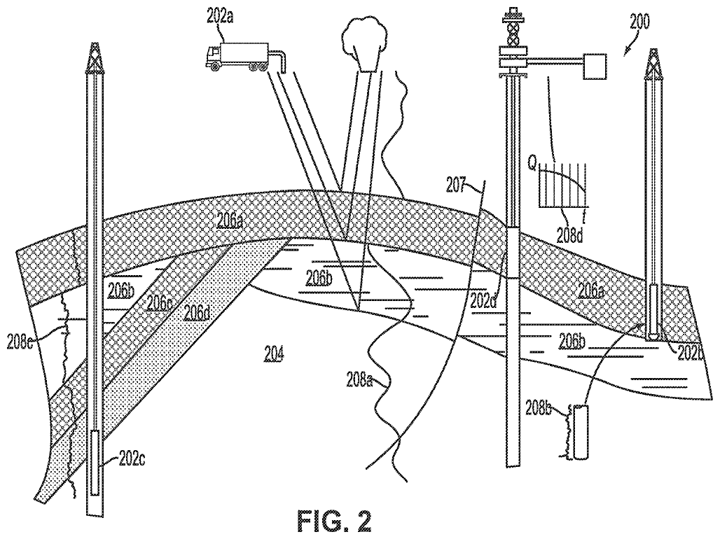

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

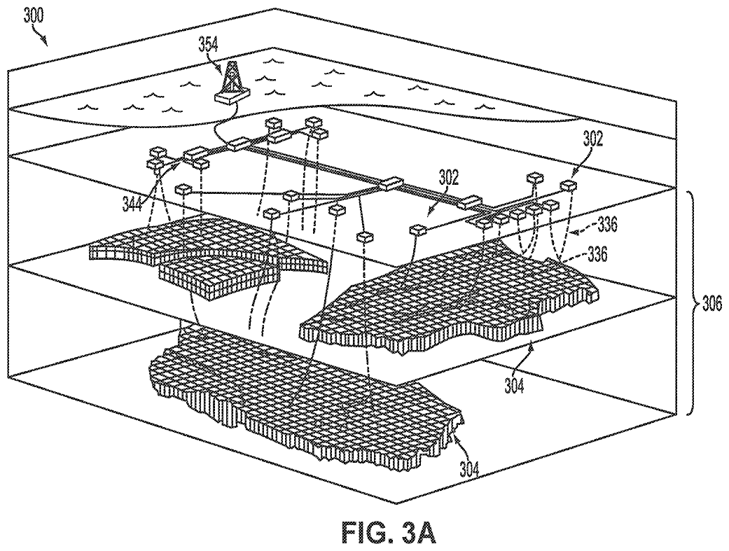

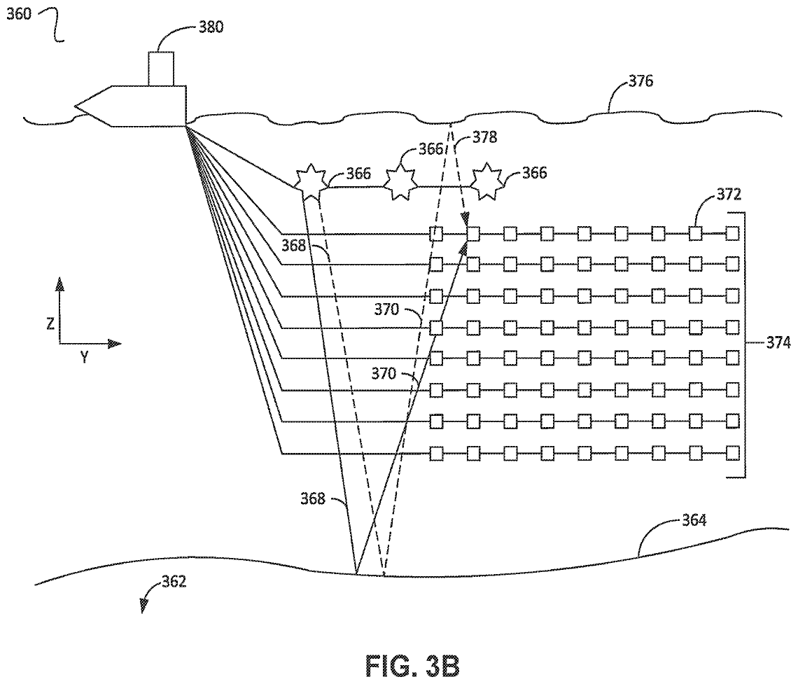

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

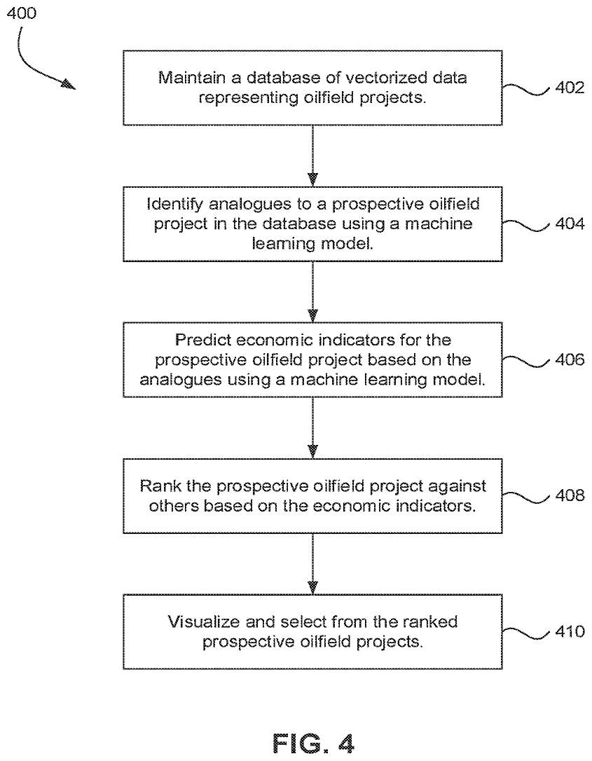

FIG. 4 illustrates a flowchart of a method 400 for field development planning, including using artificial intelligence to identify analogous “projects” and make economic predictions based thereon, according to an embodiment. It will be noted that the worksteps of the method 400 (and any other method herein) may be executed in the order illustrated; however, in at least some embodiments, the worksteps may be executed in other orders. Further, the worksteps may be combined, partitioned, executed simultaneously/in parallel, etc., without departing from the scope of the present disclosure.

The method 400 may include maintaining a database of vectorized data representing projects, as at 402. One example of such a project is an oilfield project. As the term is used herein, an “project” may be any activity that is performed in or on an oilfield, e.g., exploration, planning, drilling, completion, production, management, or other activities. Another example is an alternative energy or renewable energy project. Such projects refer to any activity (or sequence of activities) related to planning, construction, and/or operation of wind, solar, geothermal, hydrothermal, hydrogen gas, or other energy fields.

The data received at 402 represents portions of the projects that have been completed or for which data is otherwise available; however, data may become available before a project is completed, e.g., in real time or daily, etc. Thus, the projects may not be complete.

Further, the data maintained in the database may be a computer-readable representation, e.g., a vector. Vectorized datasets generally start as values for variables or “parameters” that represent an object. The variables may be formed into a vector that represents a “location” for the variables in a multi-dimensional space, i.e., coordinates. The distance between two coordinates may then be considered a quantitative measure of the difference between the datasets, e.g., similar to or used as part of a clustering process. Moreover, the datasets that represent the individual projects may not all be at the same level of completeness. For example, some projects may be at a later stage of completeness than others, and thus more data may be available for those more mature projects. Embodiments of the method 400 may be employed to make the comparisons discussed herein despite potential differences in completion, e.g., via prediction of the missing data or by appropriate weightings, etc.

The method 400 may also include identifying analogues to a prospective project in the database, using a machine learning model, as at 404. In some embodiments, as discussed herein, the vectorized datasets may be condensed via a machine learning process, such as via an autoencoder, into an embedding. Such embeddings may non-linearly reduce the dimensionality of the dataset, at least partially providing weights to the different parameters, and thus, after completion, may make the distance evaluation faster. There exist many different ways to evaluate such distance, including cosine similarity for the datasets.

In at least some embodiments, similarity scores may be generated by comparing the dataset for the prospective project with the datasets for the projects maintained in the database. Analogues may then be identified based on the similarity scores. For example, a threshold similarity score may be set, and analogues may be those from which a score exceeding the threshold is calculated. In other embodiments, statistical measures (e.g., average, standard deviation, etc.) may be employed to set the threshold dynamically.

The machine learning model implementing such a process may be trained in a supervised or unsupervised manner. In the latter example, a decoder may be paired with the encoder, and may generate a representational dataset from the embeddings. The representational dataset that is the output of the decoder may then be compared with the original, relatively high-dimension, parameterized dataset to determine a difference therefrom. The weightings of the encoder-decoder pairing may then be adjusted to reduce the difference until a desired or threshold difference of “cost” results. An example of such an encoder-decoder, machine-learning process is discussed below.

Once the analogues are identified, the method 400 may proceed to predicting (values for) one or more economic indicators for the prospective project based on the analogues, as at 406. For example, the analogues may be associated with one or more economic indicator values, such as capital expenditures (CAPEX), operating expenditures (OPEX), net present value, total production, cost per unit of hydrocarbon (e.g., cost per barrel of oil), recovery factor, internal rate of return, etc. The pairings of economic indicators and the representational datasets of the other parameters of the projects may be provided to a machine learning model. The machine learning model may be configured to detect patterns in the data, which tend to link the parameters of the projects to the economic indicators. Thus, the database may serve to train the machine learning model, using analogous projects, to predict economic indicators for the prospective projects, e.g., unsupervised learning.

Once the economic indicator values are established for a prospective project, the prospective project can be compared with other prospective projects, to assist developers in determining efficient allocation of resources. For example, as at 408, the method 400 may include ranking the prospective project against other prospective energy (or other types of) projects based on the economic indicators. In an embodiment, the same or similar economic indicators may have been established for the other prospective projects using the same or similar method to that described above.

Accordingly, without constructing expensive physical models or running numerical simulations based on scarce or unreliable data, the machine learning model may be able to provide insight into the value of a given project. In some embodiments, this could be supplemented with the results of such modelling/simulation efforts. If the value is sufficiently high (and/or the costs sufficiently low), e.g., relative to other prospective projects, a developer may be able to select the prospective project for development. To this end, the method 400, in some embodiments, may provide different visualizations, as at 410, that show the prospective project in the context of the other projects, and provide visual reference of the relative values for the economic indicators from the different historical and/or prospective projects. Further, in at least some embodiments, the method 400 may include deciding to implement the prospective project based on the predicted economic indicators and/or conducting drilling or other construction activities for the prospective project based at least in part on the predicted economic indicator values.

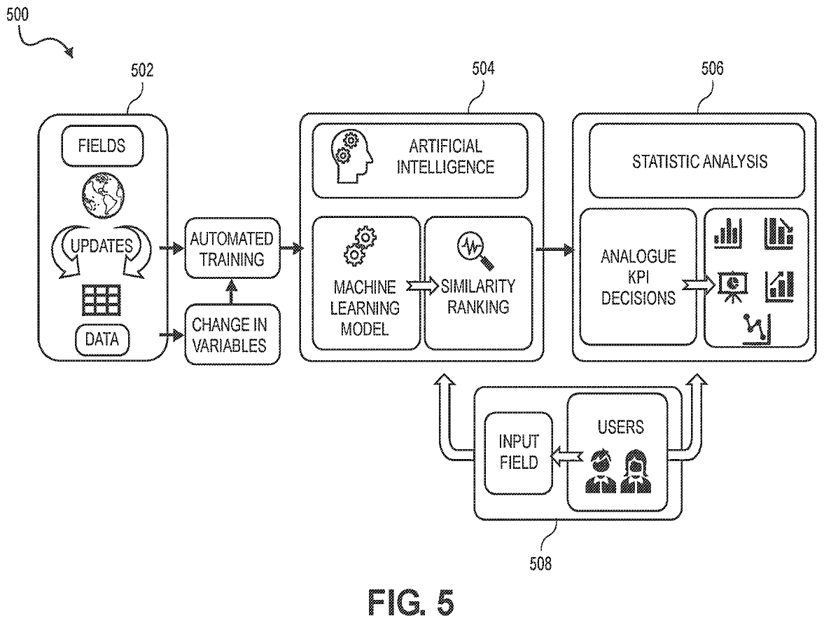

FIG. 5 illustrates a diagram of a system 500 for field planning and development, according to an embodiment. The system 500 may, for example, implement an embodiment of the method 400 discussed above. The system 500 may include a field database module 502, which may store data, and may update the data storage as updates become available. The system 500 may also include an artificial intelligence module 504. The artificial intelligence module 504 may include one or more machine learning models, e.g., autoencoder neural networks, other neural networks, generative adversarial networks, etc. For example, the machine learning models may be trained to generate embeddings representing the individual vectorized datasets of the oilfield prospects. Further, the machine learning models may be configured to identify analogues based on the similarity between the embeddings, and thus the projects represented by the embeddings, and generate similarity rankings therefrom. The machine learning models may also be configured to predict one or more values for one or more economic indicators for a prospective project based on the parameters representing (historical or at least partially complete) analogous projects.

The system 500 may further include a statistical analysis module 506. The statistical analysis module 506 may be configured to receive the analogue data and/or the predictions and to conduct statistical analyses based thereon. For example, the net present value, internal rate of return, CAPEX, OPEX, etc. may be evaluated for a prospective project against one or more other prospective projects, and determinations made as to whether to proceed with the prospective project or another, e.g., based on such a comparison.

The system 500 may also be configured to receive user inputs, as indicated at 508. The user inputs may include insights, information, selections, adjustments, etc. from the users. In some embodiments, the machine learning models may update in view of selections from the users, so as to incorporate predictions of inputs from the user into the ranking/selection process.

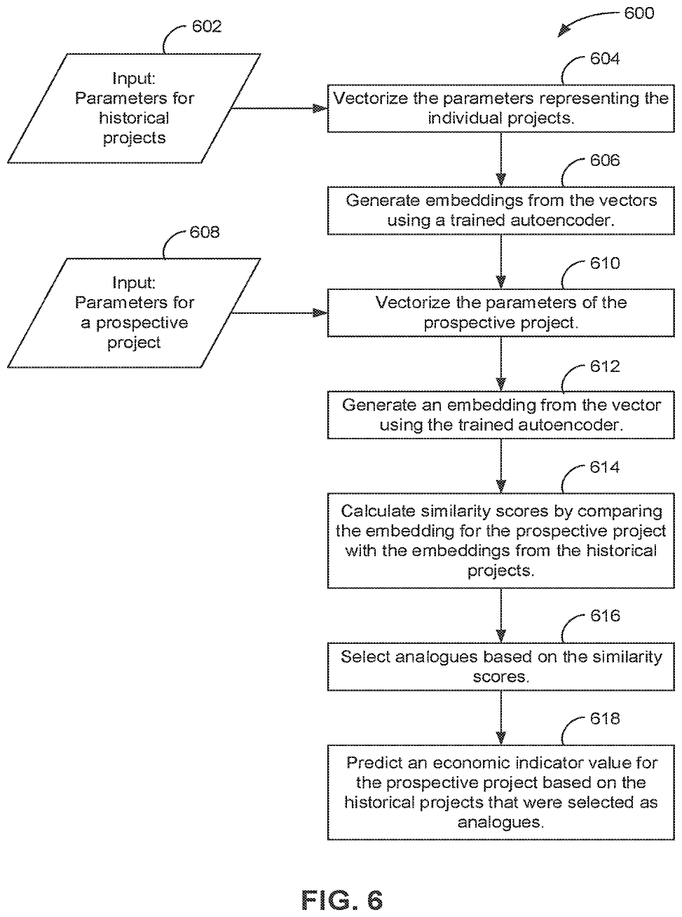

FIG. 6 illustrates another flowchart of a method 600 for field development and planning, e.g., using artificial intelligence to assist in the selection of prospective projects, according to an embodiment. The method 600 may represent a more detailed view of an embodiment of the method 400 and thus the two methods 400, 600 should not be considered mutually exclusive.

The method 600 may include receiving, as input, parameters for “historical” projects, as at 602. These parameters may be stored in a database, and receiving the parameters may refer to accessing such a database. In other embodiments, receiving the parameters may refer to any other data acquisition process. The historical projects are those for which economic information is preexisting or otherwise measurable, e.g., in contrast to prospective projects for which such information may be unknown or at least partially incomplete.

The parameters may represent any of a variety of characteristics of the projects, including physical characteristics of the subsurface through which wells extend, equipment used to construct and/or produce the wells, and/or information about the political, economic, geological, or environmental features of the area in which the project exists. Further, decisions that were made with respect to the projects may also be included in the parameters. Moreover, one or more of the parameters may be an economic indicator, which may be any variable selected that relates to an economic performance of a project. Such economic indicators may guide choices made as to whether a project is feasible, or whether resources are better used for other projects.

The method 600 may include vectorizing the parameters representing the individual projects (e.g., forming “first” vectors), as at 604. This may include forming computer-readable representations of the parameters, e.g., values, which may then be formed into an array, e.g., a vector. The vector may define a location for the dataset of parameters for a given project in a multidimensional space. It will be appreciated that the parameters for which information is available may be different as between projects, as explained above; however, such different datasets may still be vectorized for comparison later.

The method 600 may also include generating embeddings from the vectors using a trained autoencoder, or another type of machine learning model, as at 606. Continuing with the example of the autoencoder, the autoencoder may non-linearly transform the vectors into embeddings, e.g., employing different weightings. The embedding may thus represent the vectors (and thus the parameters) in a reduced dimensionality as compared to the initial computer-readable vector representations of the parameters. This may facilitate, and potentially make for faster and more accurate comparisons of the datasets of parameters.

The foregoing process of receiving parameters, vectorizing the parameters, and generating embeddings may be performed iteratively, e.g., at intervals, or when new data for an project becomes available. Accordingly, a database of the embeddings, e.g., associated with the projects being represented, may be maintained in a database.

The method 600 may include receiving parameters for a prospective project, as at 608. These parameters may be the same, or at least overlapping, with the parameters of the historical projects. As mentioned above, comparisons of datasets that have different levels of completeness may be made, and thus the set of parameters may not be identical. A prospective project may be an entirely new project, or in other embodiments, may be a next phase of a current or on-going project.

The method 600 may include vectorizing the parameters (e.g., forming a “second” vector), as at 610, and generating an embedding from the second vector, as at 612. This may be completed using the same autoencoder (or other machine learning model) as was used to form the embeddings representing the parameters of the historical projects at 606.

The method 600 may then include comparing the first vector with the second vectors, e.g., by directly comparing the embeddings generated therefrom. For example, as shown in FIG. 6, the method 600 may include calculating similarity scores by comparing the embedding for the prospective project with the embeddings from the historical projects, as at 614. The similarity scores may be based on a cosine similarity or any other measure of similarity.

Based on the similarity scores, the method 600 may include selecting analogues from the historical projects, as at 616. The analogues may be selected, e.g., because the similarity scored generated therefrom meets or exceeds a certain value (e.g., normalized against the scores for the similarity of the other embeddings). This threshold score may be static or hardcoded, or may be determined statistically, or may be user-defined.

The method 600 may then include predicting one or more economic indicator values for the prospective project based on the projects that were selected as analogues, as at 618. This may again employ or rely on machine learning/artificial intelligence. For example, the analogues may serve as training data for unsupervised training of the machine learning model. The analogues, as noted above, may specify certain parameters including economic indicators. The machine learning model may be fed the parameters and economic indicators, generally as labeled pairings. The machine learning model may thus be trained to predict the economic indicators from the patterns contained in the parameters. From this training, the machine learning model may consider the parameters known for the prospective project, and predict the economic indicator(s) that may result. These economic indicators, as noted above, may guide decisions as to whether to undertake a prospective project, or whether it is economically more beneficial to pursue other projects. Thus, the prediction of the economic indicators may provide for a straightforward comparison between the likely benefits of one project versus another.

The process of vectorizing, forming embeddings, selecting analogues, and predicting economic indicators may be repeated iteratively. For example, multiple prospective projects may be evaluated at compared. Further, analyses may be repeated/redone when new information becomes available, e.g., once a project is started or a next workstep in a project is taken.

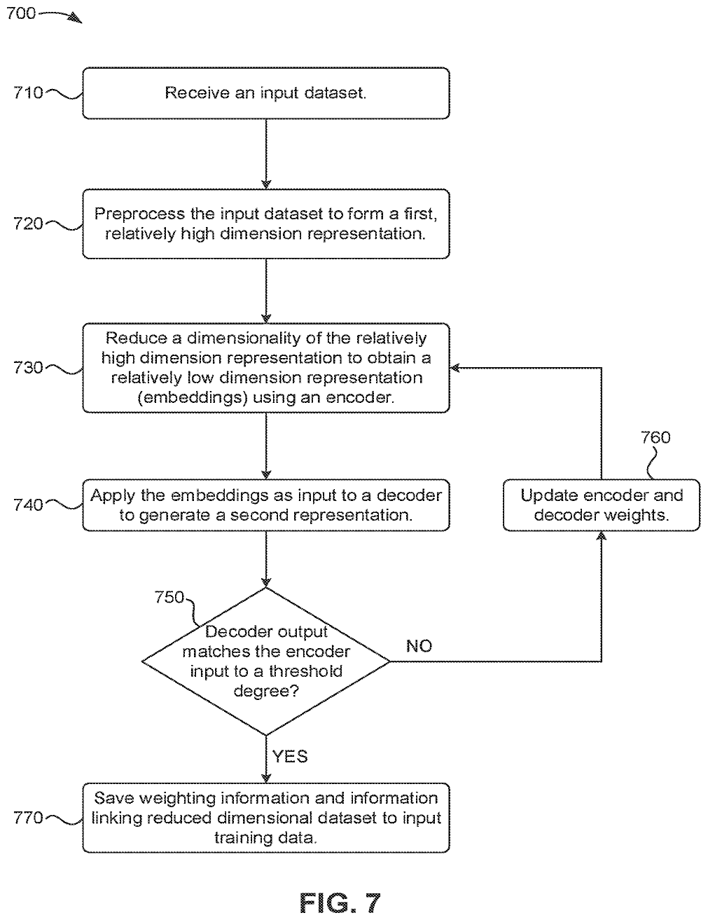

FIG. 7 illustrates a flowchart of a method 700 for training a machine learning model to construct the embeddings discussed above, according to an embodiment. The method 700 may include receiving an input dataset, as at 710. For example, the input training dataset may include data (“parameters”) representing physical, political, economic, etc. characteristics of projects (e.g., attributes previously obtained from an exploration and/or data gathering process).

The method 700 may also include preprocessing the input training dataset to form a first, relatively high dimension, computer-interpretable representation thereof, as at 720. For example, the input dataset may be vectorized so as to permit a multi-dimensional projection thereof, thereby providing a multi-dimensional “location” (e.g., coordinates) for the input training dataset. This location can be compared with other, similarly vectorized and projected datasets, for determining distance, which quantitatively measures dataset similarity. For example, the dataset may be non-linearly normalized or otherwise given values, despite the presence of different types of data (e.g., numerical, Boolean, text, etc.).

The method 700 may also include reducing a dimensionality of the first, relatively high dimension representation to generate a relatively low dimension representation thereof (“embedding”), using an encoder, as at 730. In some embodiments, the encoder may apply an algorithm and weightings to produce the embeddings from the training data, or from samples of the training data, effectively reducing the number of dimensions in the relatively high dimension representation.

The method 700 also may include applying the embeddings as input to a decoder to generate a second (e.g., training/validation) representation, as at 740, which may have the same number of dimensions as the relatively high dimension representation that was inputted to the encoder. For example, the embeddings may be input to a decoder that attempts to reconstruct training data (or alternatively, the samples from the training data), e.g., by increasing the dimensionality of the embeddings back to the relatively high dimension representation.

The method 700 further may include determining whether the second, training/validation representation that was generated by the decoder (i.e., decoder output) matches the first, relatively high dimension representation to a threshold degree, as at 750. If, for example, the decoder output does not match the encoder input to a threshold degree, the weightings of the encoder and decoder may be updated, as at 760. The method 700 may return to block 730 in which the samples from the dataset may be applied to the encoder with the updated weightings to produce a lower dimensional representation (embedding), which may be subsequently applied to the decoder, as at 740, and compared to the samples from the dataset. The cycle of updating the weightings may continue until the decoder output matches the input to the encoder to a threshold degree.

Once the decoder output matches the encoder input to a threshold degree (block 750—YES), the method 700 also may include saving the weightings (links between layers/nodes) information and information linking the embeddings to the input training data, as at 770. In this way, a machine learning model may be considered to be trained such that the machine learning model links the input training data with embeddings. The trained machine learning model may include a trained encoder, more specifically, the encoder with the saved weightings information applied to the encoder.

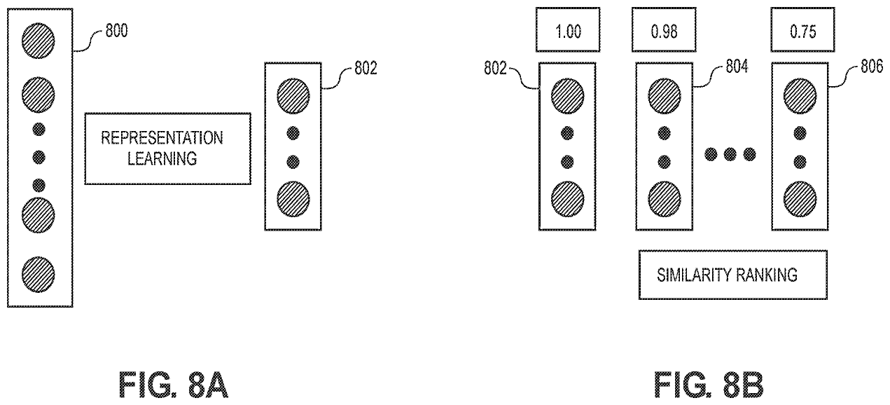

FIGS. 8A and 8B conceptually illustrate operation of the machine learning model to generate the embeddings, and then a comparison made therefrom, according to an embodiment. As shown in FIG. 8A, the larger-dimension initial dataset 800, e.g., directly representing the parameters of the project, may be received. The machine learning model may then reduce the dimensionality of this dataset into an embedding 802 via representation learning. As shown in FIG. 8B, the embedding 802 may then be compared with other embeddings 804, 806 (e.g., representing parameters from other projects), and similarity scores/ranks generated therefrom.

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

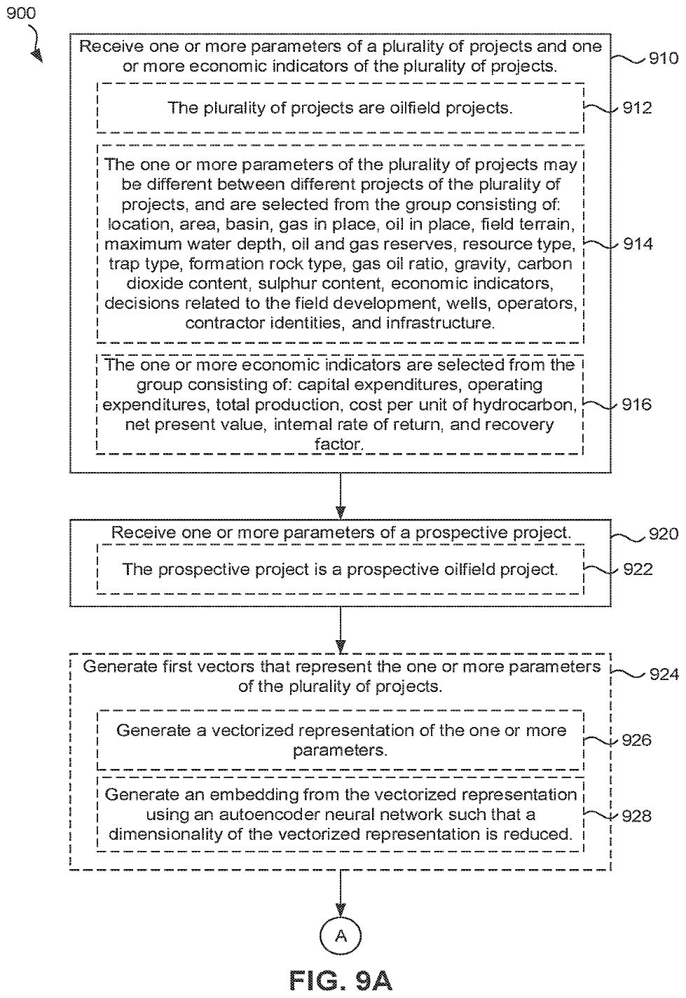

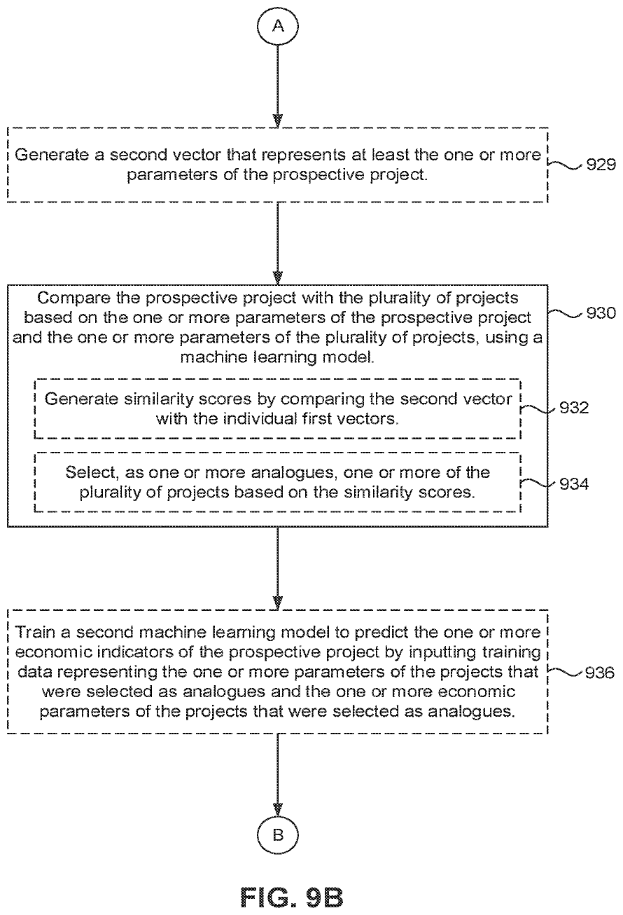

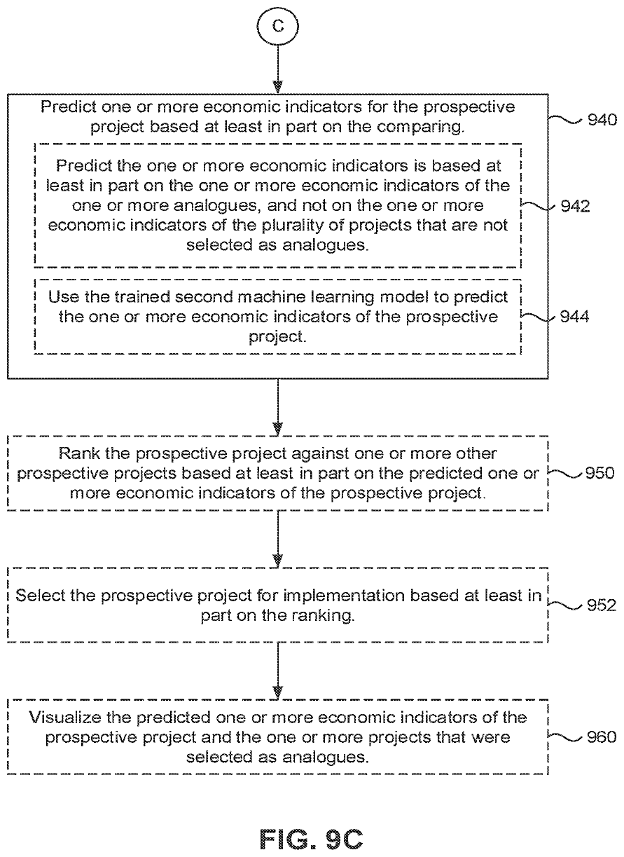

FIGS. 9A, 9B, and 9C illustrate a flowchart of a method 900, according to an embodiment. The method 900 includes receiving one or more parameters of a plurality of projects and one or more economic indicators of the plurality of projects, as at 910 (e.g., FIG. 6, 602). In a specific embodiment, the plurality of projects are oilfield projects, as at 912. Further, the one or more parameters of the plurality of projects may be different between different projects of the plurality of projects, and are selected from the group consisting of: location, area, basin, gas in place, oil in place, field terrain, maximum water depth, oil and gas reserves, resource type, trap type, formation rock type, gas oil ratio, gravity, carbon dioxide content, sulphur content, economic indicators, decisions related to the field development, wells, operators, contractor identities, and infrastructure, as at 914. The one or more economic indicators are selected from the group consisting of: capital expenditures, operating expenditures, total production, cost per unit of hydrocarbon, net present value, internal rate of return, and recovery factor, as at 916.

The method 900 includes receiving one or more parameters of a prospective project, as at 920 (e.g., FIG. 6, 608). In a specific embodiment, the prospective project is a prospective oilfield project, as indicated at 922.

In an embodiment, the method 900 includes generating first vectors that represent the one or more parameters of the plurality of projects, as at 924 (e.g., FIG. 6, 604). Generating individual first vectors of the plurality of first vectors may include generating a vectorized representation of the one or more parameters, as at 926 (e.g., FIG. 6, 604). Generating the first vectors may also include generating an embedding from the vectorized representation using an autoencoder neural network (“autoencoder”) such that a dimensionality of the vectorized representation is reduced, as at 928 (e.g., FIG. 6, 606). The method 900 may also include generating a second vector that represents at least the one or more parameters of the prospective project, as at 929 (e.g., FIG. 6, 610).

The method 900 includes comparing the prospective (e.g., oilfield) project with the plurality of (e.g., oilfield) projects based on the one or more parameters of the prospective project and the one or more parameters of the plurality of projects, using a machine learning model, as at 930 (e.g., FIG. 6, 614, generating similarity scores from the embeddings generated by the autoencoder). In an embodiment, comparing may include generating similarity scores by comparing the second vector with the individual first vectors, as at 932. Comparing may also include selecting, as one or more analogues, one or more of the plurality of projects based on the similarity scores, as at 934 (e.g., FIG. 6, 616).

In an embodiment, the method 900, as at 936, may include training a second machine learning model to predict the one or more economic indicators of the prospective project by inputting training data representing the one or more parameters of the projects that were selected as analogues and the one or more economic indicators of the projects that were selected as analogues (e.g., FIGS. 7, 750 and 760, using a decoder to train the encoder).

The method 900 includes predicting one or more economic indicators for the prospective project based at least in part on the comparing, as at 940 (e.g., FIG. 6, 618). In at least some embodiments, predicting the one or more economic indicators is based at least in part on the one or more economic indicators of the one or more analogues, and not on the one or more economic indicators of the plurality of projects that are not selected as analogues, as at 942. As indicated at 944, predicting may include using the trained second machine learning model to predict the one or more economic indicators of the prospective project.

In at least some embodiments, the method 900 may also include ranking the prospective project against one or more other prospective projects based at least in part on the predicted one or more economic indicators of the prospective project, as at 950 (e.g., FIG. 4, 408). The method 900 may also include selecting the prospective project for implementation based at least in part on the ranking, as at 952 (e.g., FIG. 4, 410). In at least some embodiments, the method 900 may include visualizing the predicted one or more economic indicators of the prospective project and the one or more projects that were selected as analogues, as at 960 (e.g., FIG. 4, 410).

In some embodiments, the methods, computer programs, systems, and computing systems described herein can be used for identifying analogues for wind farm development. Offshore wind farms involve a large number of machines (tens to hundreds of units) as well as a wide surface area (tens to hundreds of km²). The ground stratigraphy, the mechanical properties of materials and their lateral and vertical variability may be accurately determined at each foundation location. Furthermore, a knowledge of the mechanical properties of shallow sediments is used over the cable routes, between wind turbines and to the coast. Field studies provide the information regarding soils and rocks, up to a depth that will allow detecting the presence of weak formations able to impact the stability of the structure and/or generate excessive deformations (settlements). From seismic data and CPT logs, 3D subsurface models of geotechnical properties are generated. This subsurface model is used for site characterization and monitoring. The seismic data and CPT logs are also collected over time, thus providing data from which the parameters discussed above may be collected.

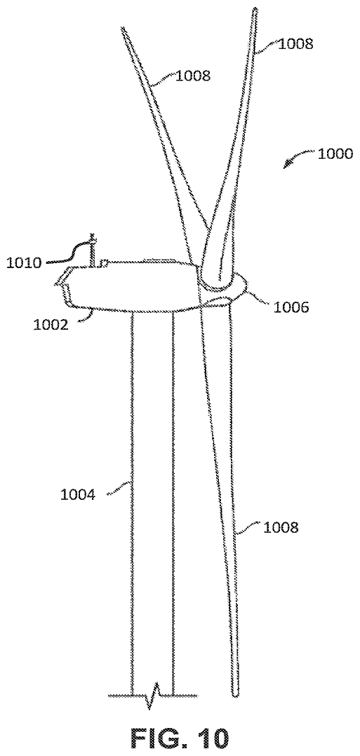

As shown in FIG. 10, a wind turbine 1000 generally includes a nacelle 1002, which houses a generator. In an embodiment, the nacelle 1002 is a housing mounted atop a tower 1004, a portion of which is shown in FIG. 10. The tower 1004 may be on land or at sea. The height of tower 1004 is selected based upon factors and conditions known in the art, and may extend to heights up to 100 meters or more. The wind turbine 1000 may be installed on any terrain providing access to areas having desirable wind conditions. The terrain may vary greatly and may include, but is not limited to, mountainous terrain or offshore locations. The wind turbine 1000 also includes a rotor 1006 that has one or more rotor blades 1008. Although the wind turbine 1000 illustrated in FIG. 10 includes three rotor blades 1008, there are no specific limits on the number of rotor blades 1008 that may be employed.

The wind turbine 1000 utilizes one or more cameras, sensors, and other devices 1010 that may emit data for transmission to a remote location for analysis to determine whether components are missing, damaged or otherwise require maintenance. In addition, if unauthorized personnel are detected, authorities or emergency services may be contacted and/or dispatched to the wind turbine 1000 and tower 1004.

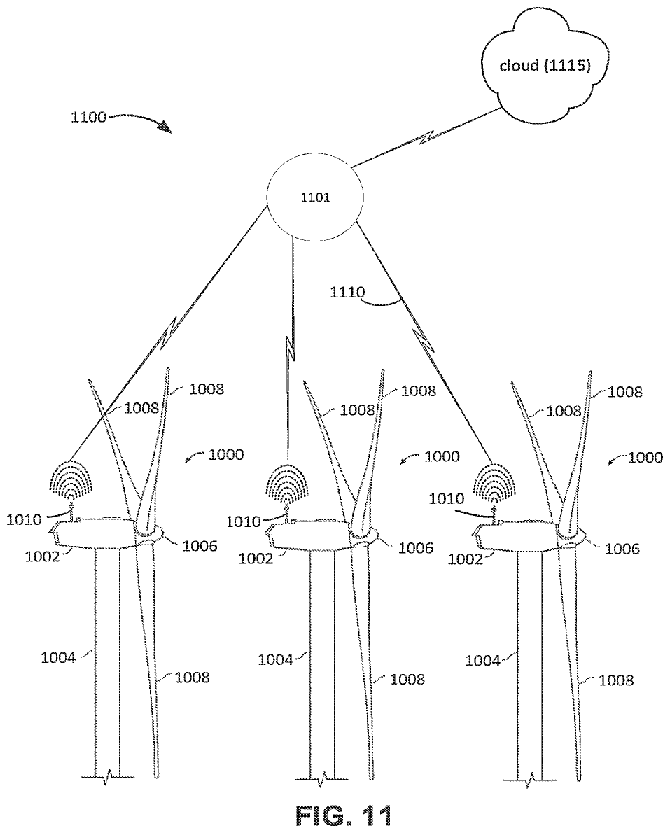

FIG. 11 illustrates a wind turbine monitoring system 1100, according to an embodiment. The system 1100 includes a central monitoring device 1101 and a plurality of wind turbines 1000 in one or more fields. Any number of wind turbines 700 may be employed in the system 1100.

A device 1010 is mounted on or within one or more of the wind turbines 1000 and respective towers 1004, and generates data 1110 that may include operating and/or environmental conditions, computational capability of the data processing infrastructure (including ability to manage and use cryptography keys, hashes and capabilities), equipment-related data, sensor data and measurements, maintenance information, visual data from camera(s), and the like. The central monitoring device 1001 may be a data acquisition device such as a computer, a data storage device, or other analysis tool. In another embodiment, the central monitoring device 1101 may be a communication device, tablet, or other computational device usable by personnel. In another embodiment the central monitoring device 1101 is the power control for a wind turbine farm or a utility operating the wind turbine farm. The central monitoring device 1101 may be autonomous or may be integrated within the wind farm control. The data 1110 may be transmitted to and/or from the wind turbine 1000 and tower 1004 in order to provide control or otherwise communicate with the wind turbine 1000 in response to a condition requiring maintenance in response to any received signals. In certain embodiments, equipment or other operational parameters may be transmitted and received.

While in FIG. 11, the data 1110 emitted from device 1010 is via wireless transmission according to typical methods, in other embodiments, wired connections, such as via ethernet, may be used for data transmission to central monitoring device 1010.

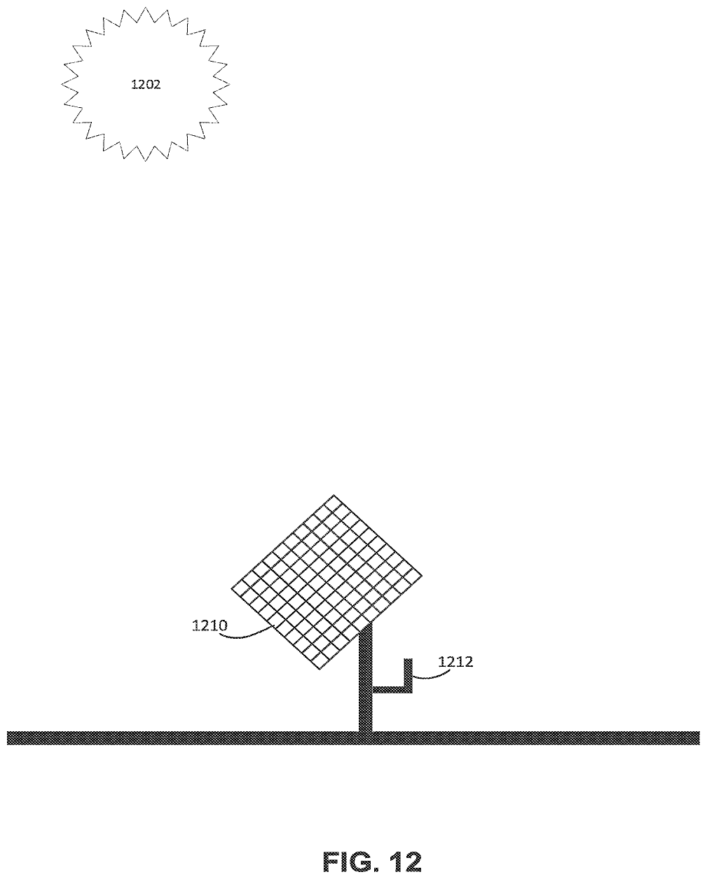

In some embodiments, the methods, computer programs, systems, and computing systems described herein can be used for identifying analogues for solar farm development. Some embodiments of the analogue identification techniques may also be employed in predicting economic indicators and selecting among projects related to solar arrays, e.g., to determine site feasibility from an economic perspective. FIG. 12 illustrates an example of such a solar power generate site 1200. The sun 1202 emits radiation collected by a solar panel 1210, which includes an instrumentation package 1212 utilizing one or more cameras, sensors, and other devices that may emit data for transmission to a remote location for analysis to determine whether components are missing, damaged or otherwise require maintenance.

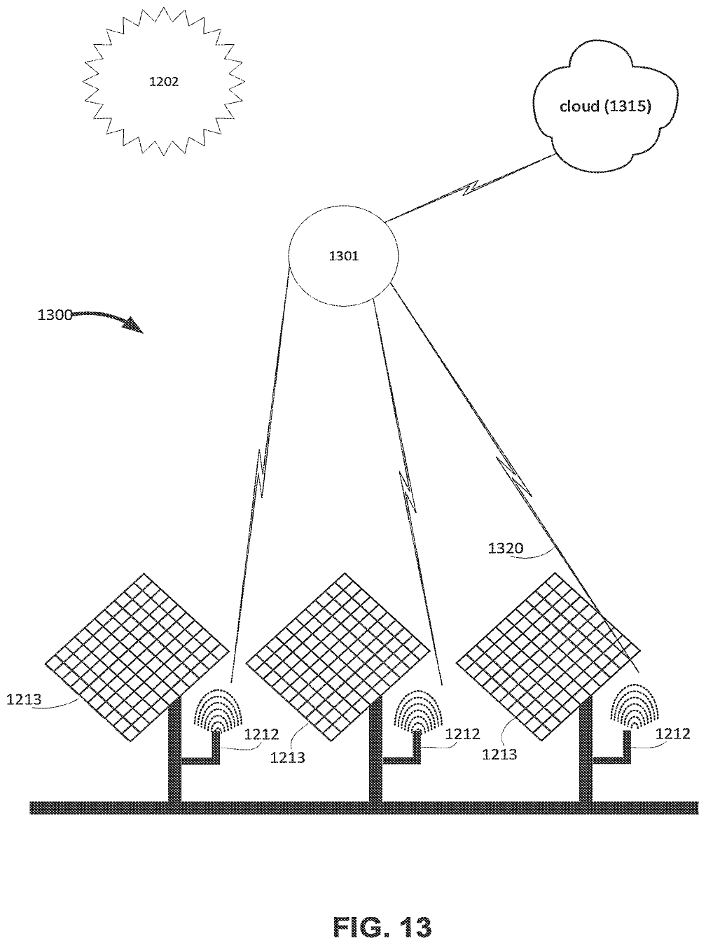

FIG. 13 shows a solar panel monitoring system 1300, according to an embodiment. The system 1300 includes a central monitoring device 1301 and a plurality of solar panels 1310 in one or more fields. The number of panels 1310 in the system 1300 is not limited and may include one or a large number of panels. Instrumentation package 1212 is mounted on or within one or more of the panels, and generates data 1320 that may include without limitation operating and environmental conditions, equipment-related data, sensor data and measurements, maintenance information, visual data from camera(s), and the like. The central monitoring device 1201 may be a data acquisition device such as a computer, a data storage device, or other analysis tool. In another embodiment, the central monitoring device 1301 may be a communication device, tablet, or other computational device usable by personnel. In another embodiment the central monitoring device 1301 is the power control for a solar panel farm or a utility operating the farm. The central monitoring device 1301 may be autonomous or may be integrated within the solar panel farm control. The data 1320 may be transmitted to and/or from the panel 1310 in order to provide control or otherwise communicate with the panel 1310 in response to a condition requiring maintenance in response to any received signals. In certain embodiments, equipment or other operational parameters may be transmitted and received.

In some embodiments, the methods, computer programs, systems, and computing systems described herein can be used for identifying analogues for carbon capture, utilization, and storage (CCUS) projects. In some embodiments, the methods can be used for predicting economic indicators for and selecting among CCUS projects. The methods may be configured to implement CO2 subsurface management (site characterization and monitoring, economic CO2 project management), e.g., to collect parameters and economic indicators. The embodiments may receive 3D surface seismic, microseismic, x-well seismic and electromagnetic data, vertical seismic profiles, surface and borehole gravity, logs, etc. The embodiments may generate porosity data, CO2 (gas) saturation, plume movement, seal integrity, injectivity, ground movement, etc. With traditional workflows, this may be considered a “big data integration” effort, calling for many manual interactions, which may be repeated when new data becomes available. With the present systems and methods, however, certain of these aspects may be skipped or automated. Thus, updating of parameter data may be facilitated.

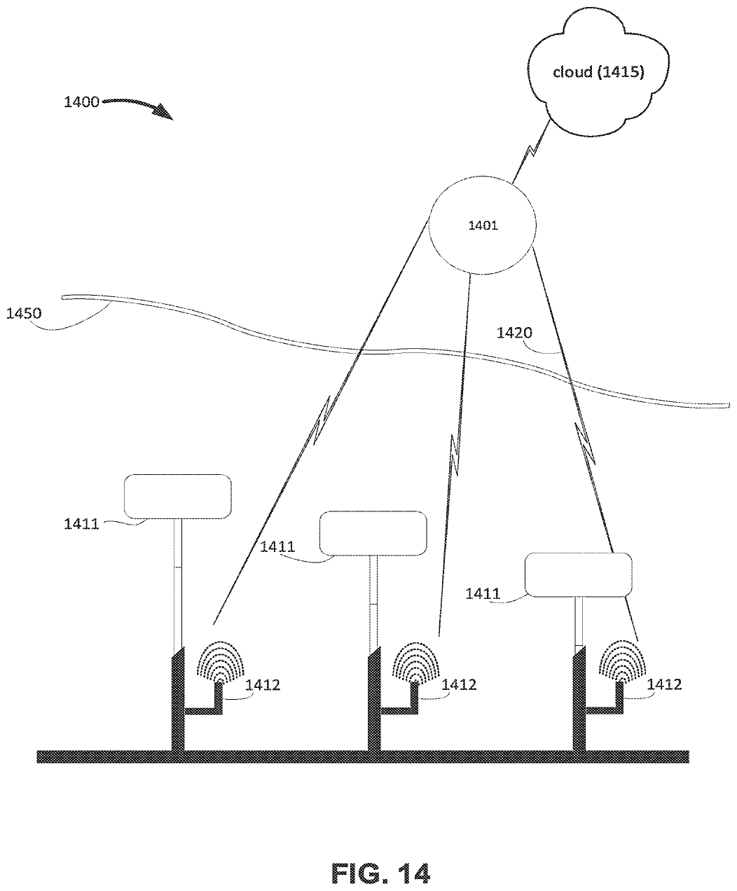

Embodiments of the present disclosure may be used with tidal and other hydrodynamic power generation sources. For example, in FIG. 14, the ocean 1450 has wave and tidal fluctuations that move one or more water-based power generation devices that include buoyant actuators 1410, whose overall system assemblies include an instrumentation package 1412 utilizing one or more cameras, sensors, and other devices that may emit data for transmission to a remote location for analysis to determine whether components are missing, damaged or otherwise require maintenance. In addition, if unauthorized personnel or testy sharks are detected, authorities or emergency services may be contacted and/or dispatched to the water-based power generation devices.

System 1400 according to an embodiment of the present disclosure includes a central monitoring device 1401 and a plurality of water-based power generation devices that include buoyant actuators 1410 in one or more fields in the sea. The number of water-based power generation devices in the system 1400 is not limited and may include one or a large number. Instrumentation package 1412 is located on or within the water-based power generation devices, and generates data 1420 that may include without limitation operating and environmental conditions, equipment-related data, sensor data and measurements, maintenance information, visual data from camera(s), and the like. The central monitoring device 1401 may be a data acquisition device such as a computer, a data storage device, or other analysis tool, either above or below the surface of the ocean 1450. In some embodiments, the central monitoring device 1401 may be on a vessel. In another embodiment, the central monitoring device 1401 may be a communication device, tablet, or other computational device usable by personnel. In another embodiment the central monitoring device 1401 is the power control facility on land for the utility operating the array of water-based power generation devices. The central monitoring device 1401 may be autonomous or may be integrated within the controls for the array. The data 1420 may be transmitted to and/or from the water-based power generation device(s) in order to provide control or otherwise communicate in response to a condition requiring maintenance in response to any received signals. In certain embodiments, equipment or other operational parameters may be transmitted and received.

In some embodiments, the methods can be used for predicting economic indicators for hydrothermal sites, by facilitating the selection of analogues and discerning patters therefrom. In such embodiments, multi-physics data (e.g., potential fields data such as electromagnetic and gravity data) are used to build a subsurface model engine. The engine may then be used for time-lapse monitoring of geothermal production. Embodiments of the present disclosure may also be used in other power generation environments, e.g., nuclear, and those with skill in the art will appreciate that the disclosed subsurface modeling capabilities may also use the disclosed artificial intelligence.

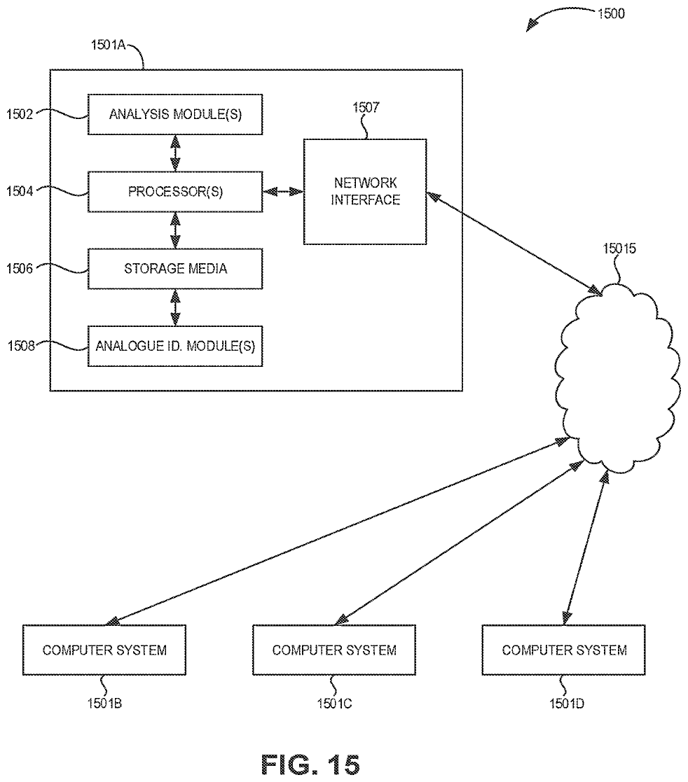

In some embodiments, any of the methods of the present disclosure may be executed by a computing system. FIG. 15 illustrates an example of such a computing system 1500, in accordance with some embodiments. The computing system 1500 may include a computer or computer system 1501A, which may be an individual computer system 1501A or an arrangement of distributed computer systems. The computer system 1501A includes one or more analysis module(s) 1502 configured to perform various tasks according to some embodiments, such as one or more methods disclosed herein. To perform these various tasks, the analysis module 1502 executes independently, or in coordination with, one or more processors 1504, which is (or are) connected to one or more storage media 1506. The processor(s) 1504 is (or are) also connected to a network interface 1507 to allow the computer system 1501A to communicate over a data network 15015 with one or more additional computer systems and/or computing systems, such as 1501B, 1501C, and/or 1501D (note that computer systems 1501B, 1501C and/or 1501D may or may not share the same architecture as computer system 1501A, and may be located in different physical locations, e.g., computer systems 1501A and 1501B may be located in a processing facility, while in communication with one or more computer systems such as 1501C and/or 1501D that are located in one or more data centers, and/or located in varying countries on different continents).

A processor can include a microprocessor, microcontroller, processor module or subsystem, programmable integrated circuit, programmable gate array, or another control or computing device.

The storage media 1506 can be implemented as one or more computer-readable or machine-readable storage media. Note that while in the example embodiment of FIG. 15 storage media 1506 is depicted as within computer system 1501A, in some embodiments, storage media 1506 may be distributed within and/or across multiple internal and/or external enclosures of computing system 1501A and/or additional computing systems. Storage media 1506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1500 contains one or more analogue identification module(s) 1508. In the example of computing system 1500, computer system 1501A includes the analogue identification module 1508. In some embodiments, a single analogue identification module 1508 may be used to perform some or all aspects of one or more embodiments of the methods. In alternate embodiments, a plurality of analogue identification modules 1508 may be used to perform some or all aspects of methods.

It should be appreciated that computing system 1500 is only one example of a computing system, and that computing system 1500 may have more or fewer components than shown, may combine additional components not depicted in the example embodiment of FIG. 15, and/or computing system 1500 may have a different configuration or arrangement of the components depicted in FIG. 15. The various components shown in FIG. 15 may be implemented in hardware, software, or a combination of both hardware and software, including one or more signal processing and/or application specific integrated circuits.

Further, the steps in the processing methods described herein may be implemented by running one or more functional modules in information processing apparatus such as general-purpose processors or application specific chips, such as ASICs, FPGAs, PLDs, or other appropriate devices. These modules, combinations of these modules, and/or their combination with general hardware are all included within the scope of protection of the invention.

Interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1500, FIG. 15), and/or through manual control by a user who may make determinations regarding whether a given step, action, template, model, or set of curves has become sufficiently accurate for the evaluation of the subsurface three-dimensional geologic formation under consideration.

In some embodiments, a computer program is provided that comprises instructions for implementing a method according to the description and method of FIG. 4 as set forth herein. In further embodiments, the computer program may be executed on a system, such as the example of FIG. 5 as executed on a computing system such as that illustrated by the example computing system shown in FIG. 15.

In some embodiments, a computer program is provided that comprises instructions for implementing a method according to the description and method of FIG. 6 as set forth herein. In further embodiments, the computer program may be executed on a computing system such as that illustrated by the example computing system shown in FIG. 15.

In some embodiments, a computer program is provided that comprises instructions for implementing a method according to the description and method of FIG. 7 as set forth herein. In further embodiments, the computer program may be executed on a computing system such as that illustrated by the example computing system shown in FIG. 15.

In some embodiments, a computer program is provided that comprises instructions for implementing a method according to the description and method of FIG. 8 as set forth herein. In further embodiments, the computer program may be executed on a computing system such as that illustrated by the example computing system shown in FIG. 15.

In some embodiments, a computer program is provided that comprises instructions for implementing a method according to the description and method of FIGS. 9A-9C as set forth herein. In further embodiments, the computer program may be executed on a computing system such as that illustrated by the example computing system shown in FIG. 15.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

What is claimed is:

1. A method for oilfield project planning, comprising:
receiving one or more parameters of a plurality of oilfield projects and one or more economic indicators of the plurality of oilfield projects;
receiving one or more parameters of a prospective oilfield project;
comparing the prospective oilfield project with the plurality of oilfield projects based on the one or more parameters of the prospective oilfield project and the one or more parameters of the plurality of oilfield projects, using a machine learning model; and
predicting one or more economic indicators for the prospective oilfield project based at least in part on the comparing.

2. The method of claim 1, further comprising:
generating a plurality of first vectors that represent the one or more parameters of the plurality of oilfield projects; and
generating a second vector that represents at least the one or more parameters of the prospective oilfield project,
wherein comparing comprises:
generating similarity scores by comparing the second vector with the individual first vectors;
selecting, as one or more analogues, one or more of the plurality of oilfield projects based on the similarity scores.

3. The method of claim 2, wherein predicting the one or more economic indicators is based at least in part on the one or more economic indicators of the one or more analogues, and not on the one or more economic indicators of the plurality of oilfield projects that are not selected as analogues.

4. The method of claim 3, further comprising training a second machine learning model to predict the one or more economic indicators of the prospective oilfield project by inputting training data representing the one or more parameters of the oilfield projects that were selected as analogues and the one or more economic indicators of the oilfield projects that were selected as analogues, wherein predicting comprises using the trained second machine learning model to predict the one or more economic indicators of the prospective oilfield project.

5. The method of claim 2, wherein generating individual first vectors of the plurality of first vectors comprises:
generating a vectorized representation of the one or more parameters; and
generating an embedding from the vectorized representation using an autoencoder neural network such that a dimensionality of the vectorized representation is reduced.

6. The method of claim 1, wherein:
the one or more parameters of the plurality of oilfield projects are different between different oilfield projects of the plurality of oilfield projects, and are selected from the group consisting of: location, area, basin, gas in place, oil in place, field terrain, maximum water depth, oil and gas reserves, resource type, trap type, formation rock type, gas oil ratio, gravity, carbon dioxide content, sulphur content, economic indicators, decisions related to field development, wells, operators, contractor identities, and infrastructure; and
the one or more economic indicators are selected from the group consisting of: capital expenditures, operating expenditures, total production, cost per unit of hydrocarbon, internal rate of return, and recovery factor.

7. The method of claim 1, further comprising:
ranking the prospective oilfield project against one or more other prospective oilfield projects based at least in part on the predicted one or more economic indicators of the prospective oilfield project; and
selecting the prospective oilfield project for implementation based at least in part on the ranking.

8. The method of claim 1, further comprising visualizing the predicted one or more economic indicators of the prospective oilfield project and the one or more oilfield projects that were selected as analogues.

9. A computing system comprising:
one or more processors; and
a memory system including one or more non-transitory computer-readable media storing instructions that, when executed by at least one of the one or more processors, cause the computing system to perform operations, the operations comprising:
receiving one or more parameters of a plurality of oilfield projects and one or more economic indicators of the plurality of oilfield projects;
receiving one or more parameters of a prospective oilfield project;
comparing the prospective oilfield project with the plurality of oilfield projects based on the one or more parameters of the prospective oilfield project and the one or more parameters of the plurality of oilfield projects, using a machine learning model; and
predicting one or more economic indicators for the prospective oilfield project based at least in part on the comparing.

10. The computing system of claim 9, wherein the operations further comprise:
generating a plurality of first vectors that represent the one or more parameters of the plurality of oilfield projects; and
generating a second vector that represents at least the one or more parameters of the prospective oilfield project,
wherein comparing comprises:
generating similarity scores by comparing the second vector with the individual first vectors;
selecting, as one or more analogues, one or more of the plurality of oilfield projects based on the similarity scores.

11. The computing system of claim 10, wherein predicting the one or more economic indicators is based at least in part on the one or more economic indicators of the one or more analogues, and not on the one or more economic indicators of the plurality of oilfield projects that are not selected as analogues.

12. The computing system of claim 11, wherein the operations further comprise training a second machine learning model to predict the one or more economic indicators of the prospective oilfield project by inputting training data representing the one or more parameters of the oilfield projects that were selected as analogues and the one or more economic indicators of the oilfield projects that were selected as analogues, wherein predicting comprises using the trained second machine learning model to predict the one or more economic indicators of the prospective oilfield project.

13. The computing system of claim 10, wherein generating individual first vectors of the plurality of first vectors comprises:
generating a vectorized representation of the one or more parameters; and
generating an embedding from the vectorized representation using an autoencoder neural network such that a dimensionality of the vectorized representation is reduced.

14. The computing system of claim 9, wherein:
the one or more parameters of the plurality of oilfield projects are different between different oilfield projects of the plurality of oilfield projects, and are selected from the group consisting of: location, area, basin, gas in place, oil in place, field terrain, maximum water depth, oil and gas reserves, resource type, trap type, formation rock type, gas oil ratio, gravity, carbon dioxide content, sulphur content, economic indicators, decisions related to field development, wells, operators, contractor identities, and infrastructure; and
the one or more economic indicators are selected from the group consisting of: capital expenditures, operating expenditures, total production, cost per unit of hydrocarbon, internal rate of return, and recovery factor.

15. The computing system of claim 9, wherein the operations further comprise:
ranking the prospective oilfield project against one or more other prospective oilfield projects based at least in part on the predicted one or more economic indicators of the prospective oilfield project; and
selecting the prospective oilfield project for implementation based at least in part on the ranking.

16. The computing system of claim 9, wherein the operations further comprise visualizing the predicted one or more economic indicators of the prospective oilfield project and the one or more oilfield projects that were selected as analogues.

17. A computer program comprising instructions, that when executed by a computer processor of a computing device, causes the computing device to:
receive one or more parameters of a plurality of oilfield projects and one or more economic indicators of the plurality of oilfield projects;
receive one or more parameters of a prospective oilfield project;
compare the prospective oilfield project with the plurality of oilfield projects based on the one or more parameters of the prospective oilfield project and the one or more parameters of the plurality of oilfield projects, using a machine learning model; and
predict one or more economic indicators for the prospective oilfield project based at least in part on the comparing.

18. The computer program of claim 17, wherein the instructions further causes the computing device to:
generate a plurality of first vectors that represent the one or more parameters of the plurality of oilfield projects; and
generate a second vector that represents at least the one or more parameters of the prospective oilfield project,
wherein comparing comprises:
generating similarity scores by comparing the second vector with the individual first vectors;
selecting, as one or more analogues, one or more of the plurality of oilfield projects based on the similarity scores.

19. The computer program of claim 18, wherein predicting the one or more economic indicators is based at least in part on the one or more economic indicators of the one or more analogues, and not on the one or more economic indicators of the plurality of oilfield projects that are not selected as analogues.

20. The computer program of claim 19, wherein the instructions further comprise training a second machine learning model to predict the one or more economic indicators of the prospective oilfield project by inputting training data representing the one or more parameters of the oilfield projects that were selected as analogues and the one or more economic indicators of the oilfield projects that were selected as analogues, wherein predicting comprises using the trained second machine learning model to predict the one or more economic indicators of the prospective oilfield project.

21. The computer program of claim 18, wherein generating individual first vectors of the plurality of first vectors comprises:
generating a vectorized representation of the one or more parameters; and
generating an embedding from the vectorized representation using an autoencoder neural network such that a dimensionality of the vectorized representation is reduced.

22. The computer program of claim 17, wherein:
the one or more parameters of the plurality of oilfield projects are different between different oilfield projects of the plurality of oilfield projects, and are selected from the group consisting of: location, area, basin, gas in place, oil in place, field terrain, maximum water depth, oil and gas reserves, resource type, trap type, formation rock type, gas oil ratio, gravity, carbon dioxide content, sulphur content, economic indicators, decisions related to field development, wells, operators, contractor identities, and infrastructure; and
the one or more economic indicators are selected from the group consisting of: capital expenditures, operating expenditures, total production, cost per unit of hydrocarbon, internal rate of return, and recovery factor.

23. The computer program of claim 17, wherein the instructions further causes the computing device to:
rank the prospective oilfield project against one or more other prospective oilfield projects based at least in part on the predicted one or more economic indicators of the prospective oilfield project; and
select the prospective oilfield project for implementation based at least in part on the ranking.

24. The computer program of claim 17, wherein the instructions further causes the computing device to visualize the predicted one or more economic indicators of the prospective oilfield project and the one or more oilfield projects that were selected as analogues.
